(19) United States
(12) Patent Application Publication
(10) Pub. No.: US 2006/0248147 A1
(43) Pub. Date: Nov. 2, 2006

(54) System and method for automatically sending messages to service personnel

(76) Inventors: Jason M. Hill, Rochester, NY (US); Michael J. Wolford, North Chili, NY (US)

Correspondence Address: FISH & RICHARDSON P.C., P.O. BOX 1022, MINNEAPOLIS, MN, 55440-1022, US

(21) Appl. No.: 11/115,680

(22) Filed: Apr. 27, 2005

(51) Int. Cl. G06F 15/16

(52) U.S. Cl. 709/206

(57) ABSTRACT

Communications with service personnel involve receiving a service request and assigning the service request to a first mobile messaging device. A first electronic message indicative of the service request is generated and communicated to the first mobile messaging device. When it is determined that a responsive answer is not received from the first mobile messaging device, another mobile messaging device assigned to respond to the service request is automatically determined. A second electronic message indicative of the service request is generated and communicated to the other mobile messaging device.

### TECHNICAL FIELD

This disclosure generally relates to notification systems for service personnel and, more specifically, to a system and method for automatically sending messages to service personnel.

### BACKGROUND

In numerous types of enterprise operations, there may arise a need for the expertise of qualified service personnel to respond to a particular condition. For example, there may be a failure in a piece of equipment or mission-critical application that seriously disrupts operations of the enterprise and that requires the expertise of a technician to correct the problem. In another example, a customer requiring support for a particular product may contact service personnel for assistance with a problem the customer has encountered. Numerous difficulties may arise in attempting to reach qualified personnel away from the office and in determining whether the request has been answered. For example, the wrong person may be contacted, messages may be lost in transit, people may neglect to activate communication devices such as pagers and wireless phones, and communication devices may be lost or otherwise left out of the user's possession. Moreover, these problems may be multiplied when different requesters use different communication methods and devices, potentially requiring service personnel to keep track of a large assortment of communication devices in addition to the difficulties described above.

### SUMMARY

Techniques for automatically sending messages to service personnel are described.

In one general aspect, communications with service personnel involve receiving a service request and assigning the service request to a first mobile messaging device. A first electronic message indicative of the service request is generated and communicated to the first mobile messaging device. A determination is made that a responsive answer is not received from the first mobile messaging device. In response, another mobile messaging device assigned to respond to the service request is automatically determined. A second electronic message indicative of the service request is generated and communicated to the other mobile messaging device.

Some implementations include one or more of the following features. Determining that a responsive answer is not received includes determining that a responsive answer is not received within a predetermined time period or receiving an answer from the first mobile messaging device and determining whether the answer received from the first mobile messaging device fulfills the service request. The electronic message is an email message. The first mobile messaging device is associated with a first person assigned to respond to the service request and the other mobile messaging device is associated with a second person assigned to response to the service request. Assigning the service request to a first mobile messaging device or determining another mobile messaging device is based at least in part on a schedule for a person associated with the first mobile messaging device or the other mobile messaging device. Assigning the service request to a first mobile messaging device or determining another mobile messaging device includes analyzing the service request to identify a requested task and identifying a person based on an association between the requested task and the person. The association between the requested task and the person is based on a ranking of a skill of the person relative to a group of persons.

In another general aspect, a memory stores personnel information associated with each of multiple persons, and each person is associated with one or more mobile messaging devices. An interface is operable to receive a service request and to communicate a message to and receive an answer from any of the mobile messaging devices. A processor is operable to identify a first person to fulfill the service request based at least in part on the personnel information and generate an electronic message indicative of the service request. The processor communicates the electronic message using the interface to at least one of the mobile messaging devices associated with the first person. A determination is made whether an answer to the message is received by the interface and a second person to fulfill the service request is automatically determined, based at least in part on the personnel information, if an answer is not received.

Some implementations include one or more of the following features. An alert is generated if no qualified persons are available to fulfill the service request. Personnel information includes a schedule associated with each of the persons and the processor determines the first person and the second person based at least partially on the schedules.

The details of one or more implementations are set forth in the accompanying drawings and the description below. Particular features will be apparent from the description and drawings and from the claims.

### DESCRIPTION OF DRAWINGS

FIG. 1 is a block diagram of a system for managing service requests and automatically sending messages to service personnel.

FIG. 2 is a flow diagram of a process for sending messages to service personnel.

FIG. 3 is a block diagram of an implementation of a system for managing service requests.

FIG. 4 is a flow diagram of an example implementation of a process for handling a service request.

### DETAILED DESCRIPTION

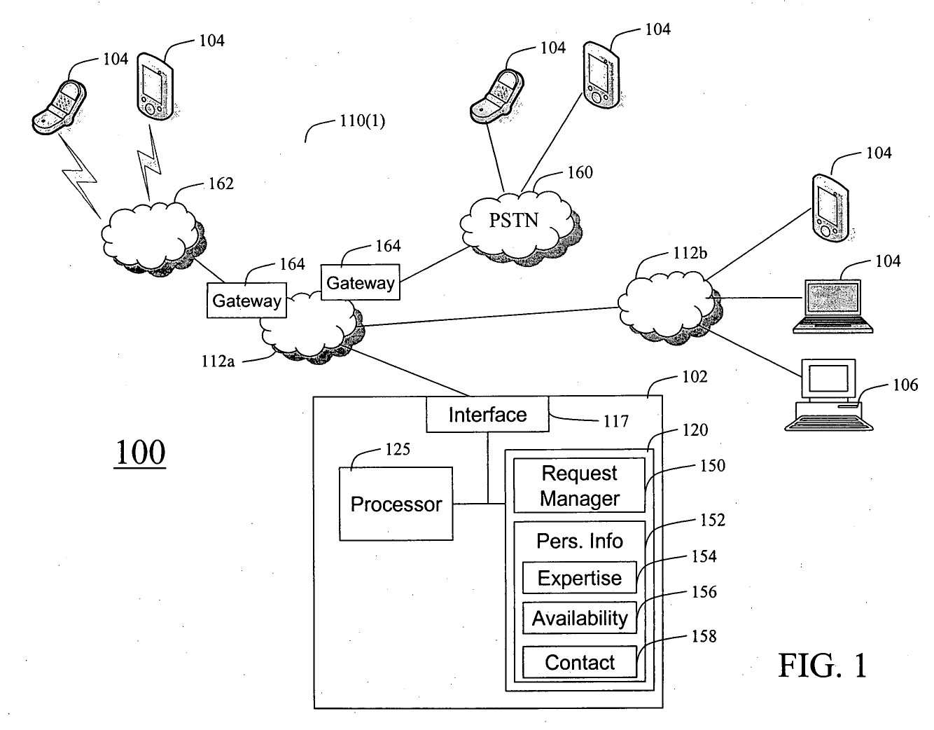

FIG. 1 illustrates a system 100 for automatically sending requests to service personnel. In a particular implementation, system 100 includes a server 102 coupled to mobile messaging devices (MMDs) 104 by a communications network 112. In general, system 100 identifies MMDs 104 associated with a request for service personnel, communicates a message to one or more MMDs 104, and determines whether a responsive reply is received from one or more of the MMDs 104 receiving a message. If a responsive reply is not received, then system 100 may escalate the request by sending a message to one or more different MMDs 104. Overall, then, system 100 provides an interactive environment for contacting service personnel to obtain a response to service requests. Among other things, the system 100 can enable a high availability of access to service personnel and help ensure more rapid response times with less effort on the part of a requestor.

Service requests may include any sort of communication to indicate the need for assistance in any manner of task. Such requests may include obtaining information, providing technical support or repair services, and the like. In general, service requests will include one or more associated tasks requiring skill or information of particular service personnel to perform them. Service requests may come from a variety of different clients, and they may pertain to a variety of different tasks. Often, particular persons may have-skills pertaining to a wide variety of clients, and conversely, different persons having relevant skills may be available at different times. One solution to the problem of locating service personnel to perform a task when they are not immediately on-site is to designate personnel as “on call,” available to be contacted in cases of emergency or when other assistance is not available. However, this may present problems when mobile messaging devices are turned off or unavailable or when the recipient is unable to determine the nature of the difficulty from the message itself, requiring the receiving party to call in for additional information.

Server 102 includes memory 120 and processor 125 and comprises an electronic computing device operable to receive, transmit, process and store data associated with system 100. For example, server 102 may be any computer or processing device such as a mainframe, a blade server, general-purpose personal computer (PC), Macintosh, workstation, Unix-based computer, or any other suitable device. Generally, FIG. 1 provides merely one example of computers that may be used. In other words, computers other than general purpose computers as well as computers without conventional operating systems can be used. As used in this document, the term “computer” is intended to encompass a personal computer, workstation, network computer, or any other suitable processing device. For example, although FIG. 1 illustrates one server 102 that may be used, system 100 can be implemented using computers other than servers, as well as a server pool. Server 102 may be adapted to execute any operating system including z/OS, Linux-Intel or Linux/390, UNIX, Windows Server, or any other suitable operating system. According to some implementations, server 102 may also include or be communicably coupled with a web server and/or an SMTP server.

MMDs 104 may be any communication device that includes the capacity for exchanging electronic messages. “Electronic messages” refers to any electronic format for communicating text information, symbols, words, numerals, characters, or other electronic representation of written language, voice, or audio, including email, instant messaging, text messaging, electronic paging, voice messages, and numerous other formats. For example, MMDs 104 may include pagers, wireless telephones, personal digital assistants (PDAs), laptops, or numerous other communication devices. MMDs 104 need not be able to exchange electronic messages directly in the appropriate format so long as information can be exchanged in some format that can be converted into electronic messages using communications systems associated with the MMD 104, such as a wireless communication network. For example, electronic messages may be converted into voice- and/or audio formats using text-to-speech conversion and the like, and similarly, electronic messages may have been generated from voice input from a user of an MMD 104.

Memory 120 may include any memory or database module and may take the form of volatile or non-volatile memory including, without limitation, magnetic media, optical media, random access memory (RAM), read-only memory (ROM), removable media, or any other suitable local or remote memory component. In the depicted embodiment, memory 120 includes a request manager 150 and personnel information 152. Request manager 150 may include code, algorithms, or other logical instructions executed by processor 125 to perform any suitable tasks associated with identifying personnel associated with a service request, communicating messages to MMDs 104, receiving responses from MMDs 104, and any other operation involved with responding to a service request. Personnel information 152 may include any form of information suitable for identifying personnel for responding to a service request and for communicating with such personnel using electronic messages. For example, personnel information 152 may include expertise information 154, availability information 156, and/or contact information 158. Personnel information 152 may be structured or organized in any suitable manner or hierarchy. For example, expertise information 154 describing skills of particular personnel at certain tasks or service requests may include a ranking of the personnel in their respective proficiency at such tasks. In another example, availability information 156 may be based on a work or on-call schedule for the personnel and may account for vacation schedules or other temporary absences. Similarly, contact information 158 may be organized with primary, secondary, and/or tertiary contact information along with rules for selecting particular contacts at particular times for example. The techniques for managing service requests described herein may be employed with such variations in the particular information used along with numerous other possible variations.

Request manager 150 can include, for example, software code for controlling an escalation of a service request through a chain of command and for accessing personnel information 152. The software code can include instructions or algorithms for determining appropriate personnel to handle a particular service request or issue based, for example, on the expertise information 154, the availability information 156, the type of service request or issue, and/or other information associated with the service request, issue, or personnel. In addition, the software code can include instructions defining when and how service requests or issues are escalated. Request manager 150 can monitor the status of a service request including coordinating communications relating to a service request that is segmented into multiple issues for sequential and/or serial handling by different personnel. In some implementations, request manager 150 can include software code that enables a textual or graphical display of the escalation process, the messages that are sent, and/or the status of the process or messages on an MMD 104 or a client computer 106 (e.g., a computer from which a service request is initially received). Such a display allows a user to conveniently monitor the status of one or more service requests and the handling thereof.

Server 102 also includes processor 125. Processor 125 executes instructions and manipulates data to perform the operations of server 102 such as, for example, a central processing unit (CPU), a blade, an application specific integrated circuit (ASIC), or a field-programmable gate array (FPGA). In particular, processor 125 performs any suitable tasks associated with request manager 150. Regarding the operation of the processor 125, the term “automatically,” as used herein, generally means that the appropriate processing is substantially performed by at least part of system 100. It should be understood that “automatically” further contemplates any suitable administrator or other user interaction with the server 102. Although FIG. 1 illustrates a single processor 125 in server 102, multiple processors 125 may be used according to particular needs and reference to processor 125 is meant to include multiple processors 125 where applicable.

Server 102 may also include interface 117 for communicating with other computer systems or devices over network 112 in a client-server or other distributed system. Generally, interface 117 comprises logic encoded in software and/or hardware in a suitable combination and operable to communicate with network 112. More specifically, interface 117 may comprise software supporting one or more communications protocols associated with communications network 112 or hardware operable to communicate physical signals.

Network 112 facilitates wireless or wireline communication between computer server 102 and any other local or remote device. Indeed, while illustrated as two networks, 112a and 112b respectively, network 112 may be a continuous network, so long as at least portion of network 112 may facilitate communications between server 102 and MMDs 104. In other words, network 112 encompasses any internal and/or external network, networks, sub-network, or combination thereof operable to facilitate communications between various computing components in system 100. Network 112 may communicate, for example, Internet Protocol (IP) packets, Frame Relay frames, Asynchronous Transfer Mode (ATM) cells, voice, video, data, and other suitable information between network addresses. Network 112 may include one or more local area networks (LANs), radio access networks (RANs), metropolitan area networks (MANs), wide area networks (WANs), all or a portion of the global computer network known as the Internet, and/or any other communication system or systems at one or more locations. Network 112 may also include telephone communication networks, such as the Public Switched Telephone Network (PSTN) 160 and/or wireless networks 162, using one or more gateways 164, which may include any device for converting signals between formats appropriate for communication in different portions of network 112. Wireless networks 162 may employ any suitable communication format or protocol, such as code-division multiplex access (CDMA), time division multiplexing (TDM), or numerous other wireless communication techniques. In particular, network 112 allows communication between server 102 and MMDs 104 using electronic messages. Processor 125 generates messages for communication to MMDs 104 as electronic messages and analyzes responses from MMDs 104 in electronic message format.

In operation, server 102 receives a service request, which may be communicated to server in any suitable manner, including but not limited to entry on an input device of server 102, voice recognition, or communication from a client computer 106 on network 112. Based on the request and the personnel information 152 stored in memory 120, the server 102 identifies an MMD 104 to receive an electronic message indicating the need for the requested service to be provided. The server 102 generates the electronic message and awaits an answer from MMD 104. When the answer is received, the server 102 determines whether the answer is responsive to the service request, based, for example, on header information that identifies whether the answer is responsive to a particular service request and/or on an analysis of data included in the answer. If the answer is responsive to the service request, then the server 102 may deem that the service request has been answered. If the answer is not responsive to the service request or if the server 102 does not receive an answer within a predetermined time period, then the server 102 escalates the request to other service personnel. To accelerate the request, the server 102 determines an MMD 104 associated with another person qualified to respond to the service request, generates an electronic message, communicates the electronic message to the MMD 104, and awaits another response. Because the server 102 manages communications with MMDs 104 using electronic message formats, which can be handled by a wide variety of communication interfaces, the server 102 need not be burdened with maintaining a variety of types of contact information associated with communicating messages in numerous different formats. Similarly, service personnel need not maintain numerous different MMDs 104 associated with different message formats and/or different types of services requests. Rather, single MMDs 104 capable of exchanging messages in an electronic message format allow the MMD 104 to serve as a contact point for all manner of service requests.

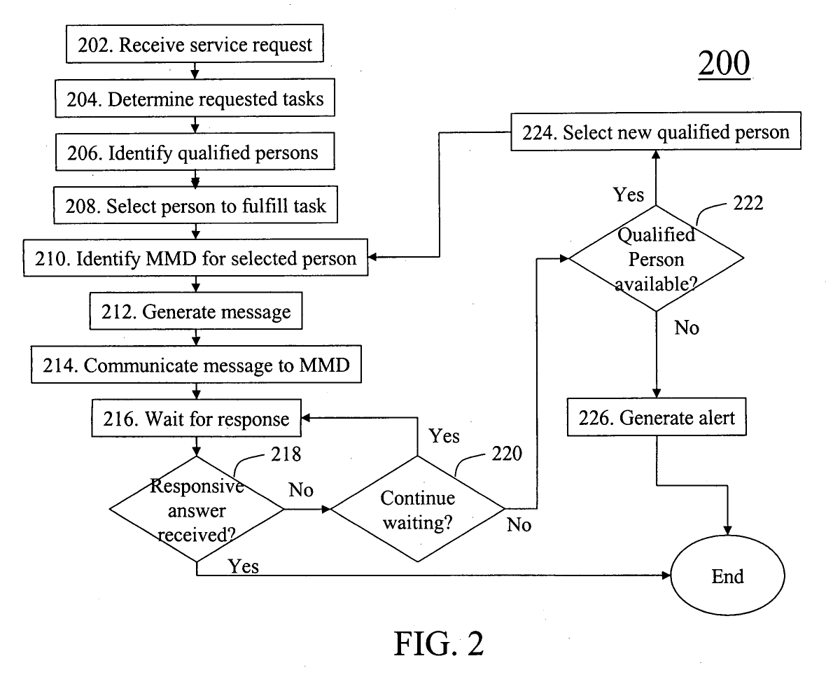

FIG. 2 is a flow diagram illustrating an example process 200 of operation for escalating service requests. A service request is received at step 202. At step 204, the service request is analyzed to determine one or more tasks requested. One or more qualified persons capable of responding to the service request are identified at step 206. Such determinations may be made based on personnel information 152, such as the various types of information described above. Depending on the task or tasks requested, a service request may require multiple service personnel to fully address the request. From the group of qualified persons, one or more is selected to fulfill the service request at step 208. An associated MMD 104 for each selected person is identified at step 210. At step 212, an electronic message is generated that indicates the tasks to be performed, and the electronic message is communicated to the MMD 104 at step 214 using contact information 158. The electronic message can be an email or a specialized electronic communication and can include a tracking identifier for associating the message with a particular issue or service ticket. The tracking identifier can be used with subsequent messages to further associate such messages with the particular issue or service ticket. In some implementations, each message throughout the escalation process can include encoded information relating to the history of the issue (e.g., identifying the sequence of messages and responses for a service request).

At step 216, the process includes a pause to wait for an answer from the MMD 104. If an answer is received at decision step 218, then a determination is made as to whether the answer is responsive to the service request. The answer can be in the form of an email or other type of electronic communication. For example, the determination may include confirming that the tracking identifier of the answer is associated with the service request and determining whether the answer is affirmative or negative. In another example, the service request may be a request for information, and the determination may include determining whether the answer includes the requested information. If the answer is responsive, then the service request may be marked as answered at step 220, and the process is complete. On the other hand, if the answer is not responsive, then a determination is made at decision step 222 whether to continue waiting for a new response. For example, the determination may include determining whether a predetermined time has elapsed since the original message was sent to the selected MMD 104. If the determination is made to continue waiting, the process returns to step 220.

If the determination at step 222 is to select a new qualified person, then a determination is made as to whether there are qualified persons remaining to respond to the service request at step 224. If no more qualified persons are available, an alert may be generated at step 226, which may in turn be used to trigger events such as bringing the situation to the attention of a user of the request management system, notifying the person requesting service that service is unavailable, or numerous other remedial actions. This completes the process of responding to the service request. If qualified persons remain to respond to the service request, a new qualified person is selected to respond to the service request at step 228. The process of generating an electronic message, communicating the message to the selected MMD 104, and waiting for a response may then be repeated from step 210 until a responsive answer is received or no more qualified persons are available to respond to the service request. Alternatively, in some implementations, once all qualified persons have been contacted without successfully receiving an answer, electronic messages can be sequentially re-sent to a hierarchy of qualified persons until a responsive answer is successfully received. In addition, each iteration of sequentially sending electronic messages to each person in the hierarchy of qualified persons can involve escalating the service to one or more higher levels or otherwise to different persons than a prior iteration.

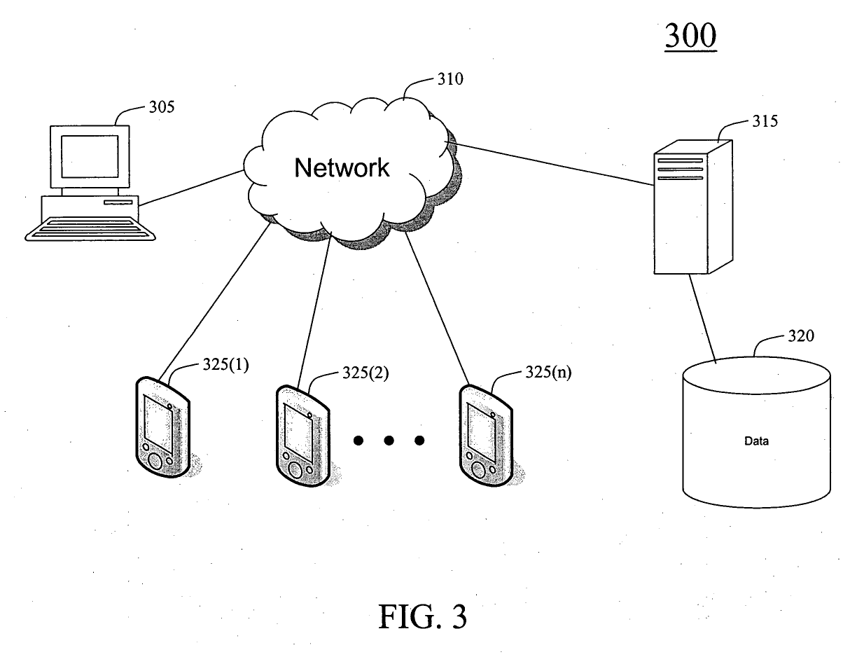

FIG. 3 is a block diagram of an implementation of a system 300 for performing a call escalation. The system includes a user device 305, such as a computer, PDA, wireless telephone, or other electronic devices. A service request is communicated from the user device 305, through a network 310, and to a server 315. For example, a user can log onto a website associated with the server 315 and log an issue or service request into a field for entering support requests. The user can also select a category (e.g., type of application or type of issue) for the support request. The server 315, in accordance with instructions executed on the server 315, analyzes the service request and determines one or more appropriate personnel for handling the service request using data stored in a database 320. In general, the server 315 sends an electronic message to an MMD 325(1) associated with a first person identified to handle the service request. If a response is not received within a predetermined period or if a received response declines the request, an electronic message is sent to an MMD 325(2) associated with a second person identified to handle the service request. Electronic messages are iteratively sent to additional MMDs 325(n) until an affirmative and/or sufficient response is received. The server 315 tracks the status of the messages and responses and identifies the MMDs 325 to which messages are sent based on data contained in the service request and/or data stored in the database 320. Information about the status of responses to the service request or an outcome of the service request can be sent to the user device 305 for display or for some other form of notifying the user, for providing patches or fixes, or for otherwise providing information responsive to the service request.

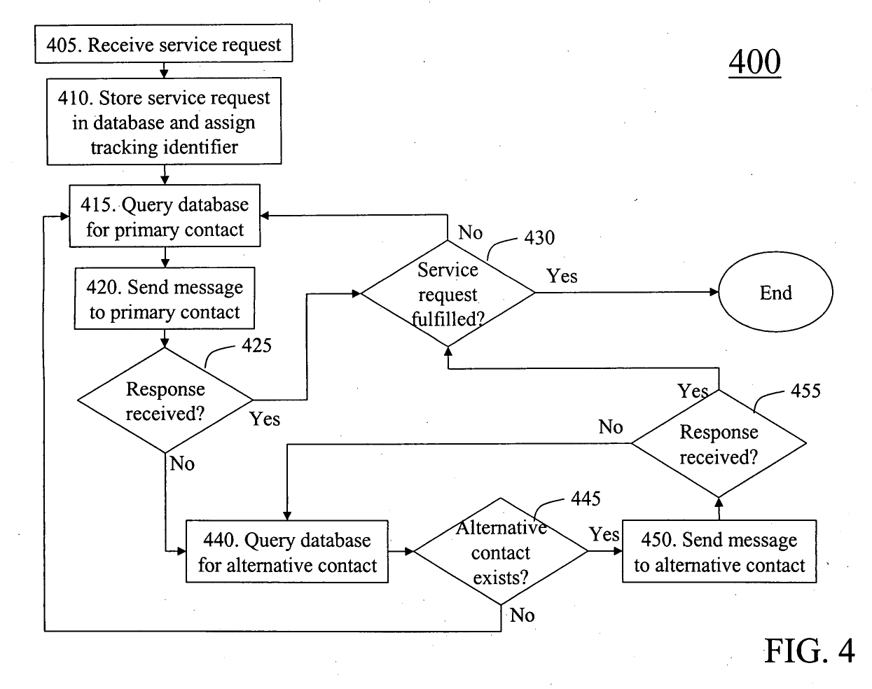

FIG. 4 is a flow diagram of a process 400 for receiving and managing service requests. A service request is received at step 405. For example, a user logs the service request into a website or transmits a formatted message containing the service request to a server. The service request is entered into a database and assigned a tracking identifier (step 410). The tracking identifier is used throughout the process 400 to correlate the service request with the various related electronic communications. The database is queried at step 415 to determine a primary contact for responding to the service request or a portion thereof. The database can store an identification of the primary contact for each different type of issue or can store characteristics and other data for each contact that is processed to identify the primary contact. An electronic message is sent to the primary contact at step 420 (e.g., by sending an email to an MMD). The electronic message includes the service request or a relevant part thereof and the tracking identifier. If an adequate response is received to the electronic message within a predetermined period (as determined at step 425), it is determined whether the response completely fulfills the service request (step 430). If so, an entry is made to the database that the requested service is complete and the process 400 ends (step 435). If the response does not completely fulfill the service request, the process 400 returns to step 415 to determine a primary contact for another issue or portion of the service request.

If an adequate response is not received at step 425, the database is queried at step 440 to determine an alternative contact for responding to the service request or a portion thereof A determination is made at step 445 as to whether an alternative contact exists. If so, an electronic message, similar or identical to that of step 420, is sent to the alternative contact at step 450. If an adequate response is received (as determined at step 455), the process 400 continues with step 430. Otherwise, the process 400 returns to step 440. If it is determined at step 445 that an alternative contact does not exist, the process 400 returns to step 415. In some implementations, only a limited number of iterations may be performed before the user is notified that service personnel are unavailable or that there will be a delay in addressing an issue and/or an alarm is generated at a service personnel management level. In addition, each iteration may include different primary and/or alternative contacts and/or may result in a higher level escalation.

The processes described above are merely examples of numerous possible methods for automatically sending messages to service personnel. Accordingly, many of the steps may take place simultaneously and/or in different orders than as shown and/or described. Moreover, processes with additional steps, fewer steps, and/or different steps can be used. For example, multiple messages may be sent out for complex tasks requiring several persons, and the system 100 may determine whether each part of the service request will be fulfilled. In another example, messages may be sent to multiple MMDs 104 associated with a person. Such messages may be sent in sequence if a response is not received, or they may be sent simultaneously.

Although the invention has been described in terms of certain embodiments and generally associated methods, alterations and permutations of these embodiments and methods will be apparent to those skilled in the art. For example, various functions of the system 100 may be consolidated within the described components or additional components, and such functions may be distributed differently among described components or additional components. Accordingly, the invention is not limited to the above description of example embodiments. Other changes, substitutions, and alterations are also possible without departing from the scope of the invention.

What is claimed is:

1. A method for communicating with service personnel, comprising:
receiving a service request;
assigning the service request to at least one first mobile messaging device;
generating a first electronic message indicative of the service request;
communicating the first electronic message to the at least one first mobile messaging device;
determining that a responsive answer is not received from the at least one first mobile messaging device;
automatically determining at least one other mobile messaging device assigned to respond to the service request;
generating a second electronic message indicative of the service request; and
communicating the second electronic message to the at least one other mobile messaging device.

2. The method of claim 1 wherein determining that a responsive answer is not received comprises determining that a responsive answer is not received within a predetermined time period.

3. The method of claim 1 wherein determining that a responsive answer is not received comprises:
receiving an answer from the at least one first mobile messaging device; and
determining whether the answer received from the at least one first mobile messaging device fulfills the service request.

4. The method of claim 1 wherein the electronic message comprises an email message.

5. The method of claim 1 wherein the at least one first mobile messaging device is associated with a first person assigned to respond to the service request and the at least one other mobile messaging device is associated with a second person assigned to response to the service request.

6. The method of claim 5 wherein at least one of assigning the service request to at least one first mobile messaging device or determining at least one other mobile messaging device is based at least in part on a schedule for at least one person associated with one of the at least one first mobile messaging device or the at least one other mobile messaging device.

7. The method of claim 5 wherein at least one of assigning the service request to at least one first mobile messaging device or determining at least one other mobile messaging device comprises:
analyzing the service request to identify at least one requested task; and
identifying at least one person based on an association between the at least one requested task and the at least one person.

8. The method of claim 7 wherein the association between the at least one requested task and the at least one person is based on a ranking of a skill of the at least one person relative to a plurality of persons.

9. An article of manufacture comprising a computer-readable medium storing instructions operable to cause the data processing apparatus to:
receive a service request;
assign the service request to at least one first mobile messaging device;
generate a first electronic message indicative of the service request;
communicate the first electronic message to the at least one first mobile messaging device;
determine that a responsive answer is not received from the at least one first mobile messaging device;
automatically determine at least one other mobile messaging device assigned to respond to the service request in response to determining that a responsive answer is not received;
generate a second electronic message indicative of the service request; and
communicate the second electronic message to the at least one other mobile messaging device.

10. The article of claim 9 wherein determining that a responsive answer is not received comprises determining whether a responsive answer is not received within a predetermined time period.

11. The article of claim 9 wherein determining that a responsive answer is not received comprises:
receiving an answer from the at least one first mobile messaging device; and
determining whether the answer received from the at least one first mobile messaging device fulfills the service request.

12. The article of claim 9 wherein the electronic message comprises an email message.

13. The article of claim 9 wherein at least one of assigning the service request to at least one first mobile messaging device or determining at least one other mobile messaging device is based at least in part on a schedule for at least one person associated with one of the at least one first mobile messaging device or the at least one other mobile messaging device.

14. The article of claim 9 wherein at least one of assigning the service request to at least one first mobile messaging device or determining at least one other mobile messaging device comprises:
analyzing the service request to identify at least one requested task; and
identifying at least one person based on a skill to perform the at least one requested task, wherein one of the at least one first mobile messaging device or the at least one other mobile messaging device is associated with the at least one person.

15. The software of claim 14 wherein the skill of the at least one person is ranked relative to a plurality of persons.

16. A request manager, comprising:
a memory storing personnel information associated with a plurality of persons, wherein each person is associated with at least one mobile messaging device;
an interface operable to receive a service request and further operable to communicate a message to any of the at least one mobile messaging devices and receive an answer from any of the at least one mobile messaging devices; and
a processor operable to:
determine a first person to fulfill the service request based at least in part on the personnel information;
generate an electronic message indicative of the service request;
communicate the electronic message to at least one of the at least one mobile messaging devices associated with the first person using the interface;
determine whether an answer to the message is received by the interface; and
automatically determine, based at least in part on the personnel information, a second person to fulfill the service request if an answer is not received.

17. The request manager of claim 16 wherein the processor is further operable to:
determine whether an answer to the message received by the interface is responsive to the service request; and
automatically determine, based at least in part on the personnel information, a third person to fulfill the service request if the answer is not responsive.

18. The request manager of claim 16 wherein the processor is further operable to generate an alert if no qualified persons are available to fulfill the service request.

19. The request manager of claim 16 wherein the electronic message is an email.

20. The request manager of claim 16 wherein:
the personnel information comprises a schedule associated with each of the plurality of persons; and
the processor determines the first person and the second person based at least partially on the schedules.

21. The request manager of claim 16 wherein the processor is further operable to
determine whether a predetermined time period has elapsed from the time at which the message was communicated to the at least one mobile messaging device associated with the first person; and
determine the second person to fulfill the request if an answer responsive to the message has not been received in the predetermined time period.

22. The request manager of claim 16 wherein the personnel information comprises a skill rating for each of the plurality of persons relative to a particular task.
